(19) United States
(12) Patent Application Publication
(10) Pub. No.: US 2026/0187431 A1
(43) Pub. Date: Jul. 2, 2026

(54) Method for Identifying Parallel Connections in Power Supply Facilities

(71) Applicant: Siemens Aktiengesellschaft, Muenchen (DE)

(72) Inventor: Markus Troyer, Neulengbach (AT)

(21) Appl. No.: 19/132,237

(22) PCT Filed: Nov. 21, 2023
(86) PCT No.: PCT/EP2023/082599

§ 371 Date: May 22, 2025

(30) Foreign Application Priority Data
Nov. 24, 2022 (EP) 22209307.2

(51) Int. Cl. G06N 3/0499; G06N 3/08

(52) U.S. Cl. CPC G06N 3/0499; G06N 3/08

(57) ABSTRACT

A method for identifying parallel connections of output channels in power supply facilities, in which, in order to identify the parallel connections, a neural network implemented in a first digital computer of a monitoring facility is provided, wherein, in order to ascertain training data for the neural network in a power supply facility, different operating states are triggered and the associated voltage waveforms and/or current waveforms at the output channels are measured, wherein the training data is transmitted to a further digital computer, via which the training of the neural network occurs, and wherein the trained, ready-to-use neural network is implemented in the first digital computer of the monitoring facility and is used to identify parallel connections.

### CROSS-REFERENCE TO RELATED APPLICATIONS

This is a U.S. national stage of application No. PCT/EP223/082599 filed 21 Nov. 2023. Priority is claimed on European Application No. 22209307 filed 24 Nov. 2022, the content of which is incorporated herein by reference in its entirety.

### BACKGROUND OF THE INVENTION

### 1. Field of the Invention

The invention relates to a method for identifying parallel connections, in particular in power supply facilities.

### 2. Description of the Related Art

The advantages of electronic fuses in the field of industrial DC voltage supplies compared to conventional safety fuses or electromagnetic triggers lead to an increasing prevalence of these fuses.

With the increasing performance of these DC voltage supplies, the demands placed on the fuses also increase.

A particular challenge is represented in this context by the parallel operation of channels of the power supplies, as is usual to increase the output power. Different operating situations, such as channel startup, overcurrent protection, shutdown, and/or setpoint value specification, must be calibrated to the parallel operation.

By automatically identifying a parallel connection of channels, it is possible for the monitoring facility to identify this at an appropriately early stage and adjust to this.

EP2812969 B1 describes the operation of power supplies with outputs that can be connected in parallel. In this context, different methods are proposed, in order to establish whether two or more output channels have been connected in parallel. A first method comprises a contacting clip which, via which an integrated switch or other electronic contact of the monitoring facility, signals the parallel connection and at the same time produces the power contact.

In order to identify a parallel connection without a connection piece, it is provided that, during a startup procedure of the power supply, a parallel connection of the outputs is initially checked by first starting the first converter unit and, in this context, detecting the output voltage as an identification signal at the output of the second converter unit. If the output voltage of the second converter unit already increases with the output voltage of the first converter unit, then a parallel connection is identified.

The disadvantage of the solution described is primarily the elaborate implementation.

### SUMMARY OF THE INVENTION

It is an object of the present invention to provide a method with which the identification of parallel connections is improved.

This and other objects and advantages are achieved in accordance with the invention by a method for identifying parallel connections of output channels in power supply facilities, in which, in order to identify the parallel connections, a neural network implemented in a first digital computer of a monitoring facility is provided, in which, in order to ascertain training data for the neural network in a power supply facility, different operating states are triggered and the associated voltage waveforms at the output channels are measured, where the training data is transmitted to a further digital computer, via which the training of the neural network occurs, and where the trained, ready-to-use neural network is implemented in the first digital computer of the monitoring facility and is used to identify parallel connections.

In classic programming paradigms, the rules of an IT-related problem formulation are defined at the outset and are subsequently implemented in source code via decision trees, such as via if{ }-else{ } statements. The challenge in this context lies in the detecting of, where possible, all possible states in one unified set of rules. This set of rules is accordingly inflexible and can only be adapted to changing circumstances, which have not been considered in advance, with difficulty.

Artificial neural networks (ANN) offer another problem-solving-oriented approach for this. The IT-related problem formulation is abstracted (model formation) and the rule-finding is left to the model itself via a learning procedure.

During this learning procedure, the model is provided with data sets, which have been ascertained by measurement in advance, as input parameters and with the associated categories as output parameters of the model.

By statistical optimization methods, an attempt is made to map the input data to this output data. In relation to the problem formulation of the parallel connection, prior to the learning procedure series of tests are performed, in which different load conditions with and without parallel connection are taken into consideration. This measurement data is used as a basis for the input data of the model, and the categorization as “parallel” or “single” is used as an output parameter.

After running through the learning procedure, including all subsequent validation and testing of the neural network, a trained model is obtained as a result, which is transferred to the monitoring facility, such as a microcontroller, where it is used as part of what is known as “inference”.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in further detail on the basis of figures, in which, shown by way of example, in which:

FIGS. 1a, 1b show first training data sets;

FIGS. 2a, 2b show second training data sets;

FIG. 3 shows the topology of a neural network;

FIG. 4 shows a process flow of the method in accordance with the invention for identifying parallel connections;

FIG. 5 shows a process flow of the method in accordance with the invention integrated into the device startup; and

FIG. 6 shows a process flow of the method in accordance with the invention using the current waveform

### DETAILED DESCRIPTION OF THE EXEMPLARY EMBODIMENTS

In accordance with the of the invention, training data is initially collected in a first step for the learning procedure of the neural network. To this end, via the monitoring facility of the power supply, typically a microcontroller, different operating states are triggered, i.e., a series of tests with different load conditions with and without parallel connection are performed and the output voltage waveforms U_{outCh1}, U_{outCh2} or, if applicable, the current waveforms at the channels are measured.

The term “power supply” in this context includes power adapters and/or electronic fuses and/or is understood to mean a combination of the two.

The measured values are digitized via analog-digital converters Scan ADC and written into a buffer memory. The scan duration can be calibrated to the test sequence via the storage size of the buffer, such as n=200Sample, and the conversion time of the analog-digital converter.

Preferably, the output data of the analog-digital converter is written directly into the memory via Direct Memory Access, without the computing core of the monitoring facility or of the controller being subjected to load in this context.

In the exemplary embodiment, the test data is measured by the monitoring facility. Under particular requirements, however, it may be expedient to have a dedicated piece of hardware perform this measurement of the test data and the formation of the input tensor for the neural network.

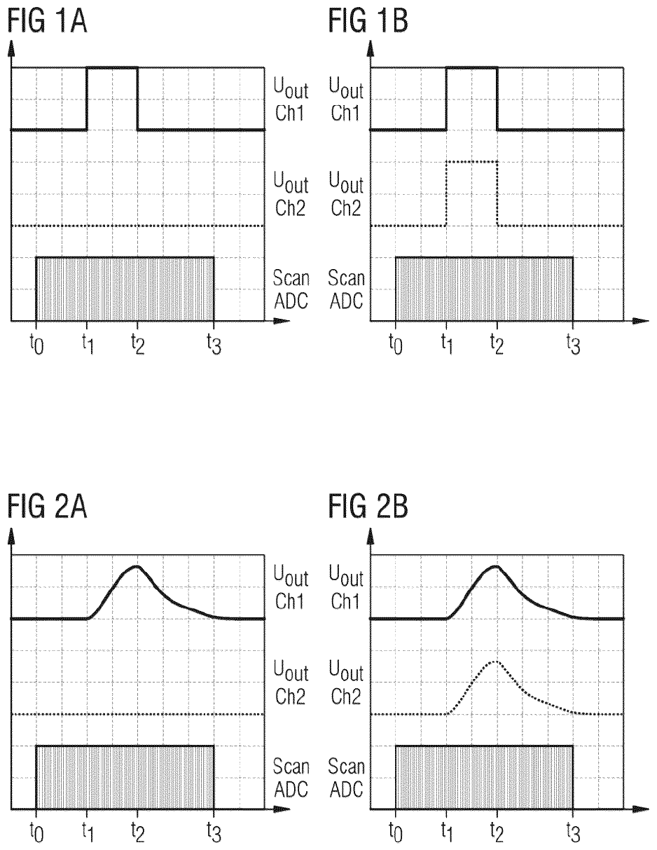

An exemplary load pattern, as represented in FIG. 1a for independent channels and in FIG. 1b for output channels connected in parallel, comprises a test pulse at a first channel of the power supply in the timeframe t1 to t2. This should be restricted in terms of time such that the load behind it does not start unintentionally.

Typical values for this are several 100 μs.

As it is assumed that not only linear loads are connected to the power supply, but also those which subsequently have a compensating procedure, the measurement procedure proceeds beyond the pulse duration up to time t3, so that decay procedures can be detected at least partially.

After this, the sampled measurement data of the output channels under consideration, such as n−sampling values, is present in an alternating manner for both channels in the memory (with increasing memory address) of the microcontroller

$$〈 UCh 1 [ 0 ] UCh 2 [ 0 ] UCh 1 [ 1 ] UCh 2 [ 1 ] … UCh 1 [ n - 1 ] UCh 2 [ n - 1 ] UCh 1 [ n ] UCh 2 [ n ] 〉$$

This arrangement depends upon the configuration of the microcontroller and the measurement channels.

The index n numbers the discrete sampling time of the analog-digital converter. The number of sampling time and the number of channels to be detected determine the size of the memory required and also the order of the data in the memory.

With j as index of the memory address, the measurement values are mapped in the memory as follows:

$$〈 UCh 1 [ 0 ] UCh 2 [ 1 ] UCh 1 [ 2 ] UCh 2 [ 3 ] … UCh 1 [ j - 3 ] UCh 2 [ j - 2 ] UCh 1 [ j - 1 ] UCh 2 [ j ] 〉$$

It would also be conceivable to sample the output voltages with multiple analog-digital converters and to store the data in different memory areas.

The correct, matching arrangement and order of the data, both during training and during operation, is essential for successful use, the inference, of the neural network. Deviations therefore must be corrected in good time.

If the requirements are met, then it is possible to run through the test sequence multiple times. In this context, data sets are initially collected, in which the channels have been operated both while connected in parallel and individually. Through the signal waveform of the output voltages, different data sets are therefore obtained for individual channels FIG. 1a, FIG. 2a and for parallel connection FIG. 1b, FIG. 2b.

In order to train the neural network on different load situations from the outset, it makes sense to perform the repetitions with alternating loads. Purely ohmic loads have an approximate voltage waveform according to FIGS. 1a, 1b. In the case of loads with a capacitive component, the output voltage increases with a delay, and in this context is smoothed out and, if applicable, time-offset, as shown in FIGS. 2a, 2b. Furthermore, it also makes sense to vary the input voltage of the electronic fuse, in order to cover the entire range of operating voltages.

For optimal training results, the variation of the parameters preferably occurs at random.

The training of the neural network and the preprocessing of the data preferably do not occur in the first digital computer of the monitoring facility, but rather via a further digital computer that is independent therefrom, such as a commercially available personal computer.

The test data measured by the monitoring facility is therefore transferred to the personal computer and undergoes preprocessing.

In doing so, this test data is initially categorized, into “parallel” and “single” in the example.

Standardizing the raw data to the value 1024 (2¹⁰) and processing on a floating-point basis are also expedient.

Subsequently, the standardized raw data are written into a tensor—a matrix—and form what is known as the input tensor.

If, for example, n samples are recorded for each run of the test sequence, and the run is repeated k times (k records), where a matrix is produced with the form [k,i].

$$[ \begin{matrix}\text{?} [ 0 ] & \text{?} [ 0 ] & … & \text{?} [ n - 1 ] & \text{?} [ n - 1 ] & \text{?} [ n ] & \text{?} [ n ] \\ ⋮ & ⋮ & … & ⋮ & ⋮ & ⋮ & ⋮ \\ \text{?} [ 0 ] & \text{?} [ 0 ] & … & \text{?} [ n - 1 ] & \text{?} [ n - 1 ] & \text{?} [ n ] & \text{?} [ n ]\end{matrix} ]$$

$$\text{?} \text{indicates text missing or illegible when filed}$$

As two channels are sampled at the discrete times n, the buffer must have the dimension j, where

$$j = 2 n$$

At the time of the data detection, it is known whether the output channels were connected in parallel. Accordingly, it is possible for categories to be assigned to the individual rows of the matrix, with “parallel” or “single”. These categories must be mapped numerically. This process is referred to as “hot encoding”.

The numerical representation is part of the problem abstraction and is necessary for the algorithm for rule finding purposes. The hot encoding is a simple numerical allocation.

$$[ \begin{matrix}1 & 0 \\ 0 & 1\end{matrix} ] = [ \begin{matrix}Parallel \\ Single\end{matrix} ]$$

This makes it possible to hand over the input tensor, consisting of the test data and the allocation of the state “parallel” or “single”, to the neural network for training purposes. The input tensor in this context has a dimension [k,j] and, by allocating the state row-by-row, a matrix is produced with the form [k,2]. This matrix is referred to as output tensor.

Neural networks are mostly based on the interconnection of many McCulloch-Pitts neurons or slight variations therefrom. In principle, it is also possible for other artificial neurons to be used, such as the high-order neuron. The topology of a network (the assignment of connections to nodes) must be appropriate for the task.

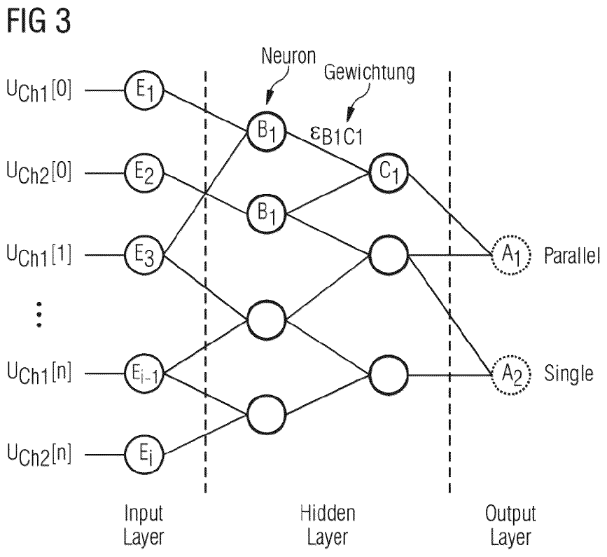

As shown by way of example in FIG. 3, in the present exemplary embodiment what is known as a multilayer feed-forward network is used which, in addition to input layer E1, E2 . . . and output layer A1, A2, also comprises hidden layers B1 . . . , C1 . . . , of which the outputs outside of the network cannot be seen. In the case of feed-forward networks, a layer is always only connected to the next-highest layer. Hidden layers improve the abstraction of the network.

The number of neurons in the input layer E1, E2 . . . corresponds to the number of samples of the analog-digital converter. The number of neurons in the output layer A1, A2 corresponds to the number of possible results, i.e., “parallel” or “single” or the statement parallel connection yes/no.

Following the construction of a network, there is the training phase, in which the network “learns”, mainly by modifying the weights of the neurons.

The training of the neural network proceeds in a computer-assisted manner via conventional programs. Specialized software programs such as TensorFlow Lite, Keras, Lasagne, Caffe, ONNX, and/or Matlab are suitable for this purpose. As a result of the training process, each piece of software delivers a file that contains the functional neural network.

As evident in FIG. 3, the individual neurons between the layers are connected by weightings ε_{B1C1}. Here, “a path” is sought by the network and is described by what is known as an activation function, which reads as follows, for example:

$$( E 1 {ε}_{E 1 B 1} + E 3 {ε}_{E 3 B 1} ) + B 1 {ε}_{B 1 C 1} + C 1 {ε}_{C 1 A 1}$$

During the training, this path is run through with initialization values for the weighting. By expansion and addition, a numerical value for the first output node A1 is produced along the path. This procedure is called forward propagation. The “true” value for the first output node A1 is known in the training process. As a result, the deviation between the computed result and the actual value is ascertained. The deviation, or the error, gives information on how the weighting factors have to be reweighted. Here, the path is counted back to the first output node A1. This procedure is called backpropagation.

This procedure is repeated until the errors are mapped to be as small as possible for all instances of the input tensors. This optimization procedure would theoretically run endlessly. Accordingly, the number of runs that are to occur, referred to as epochs, is expediently specified during training. By observing the error rate from epoch to epoch, it is possible to identify whether a model would be trained sufficiently.

For the training, the available data is preferably divided into training data, validation data and test data, where for example 60% of the data is used for the pure training and 20% is used for the validation of the model, so that anomalies in the data can be established. This is intended, for example, to prevent statistical deviations from being overvalued in the data.

Finally, 20% of the data is used to test the network. This means that a known data set is available that the model has never seen during training and can be used to review whether the neural network also delivers plausible results with new data sets.

The file that is now available with the functional neural network is consequently converted into a format that can be used for the monitoring facility of the power supply—a microcontroller.

This occurs inter alia by converting into a HEX file, which subsequently can be incorporated into the source code of the microcontroller, such as a given programming library (model.h and model.c) with corresponding parameters and handlers.

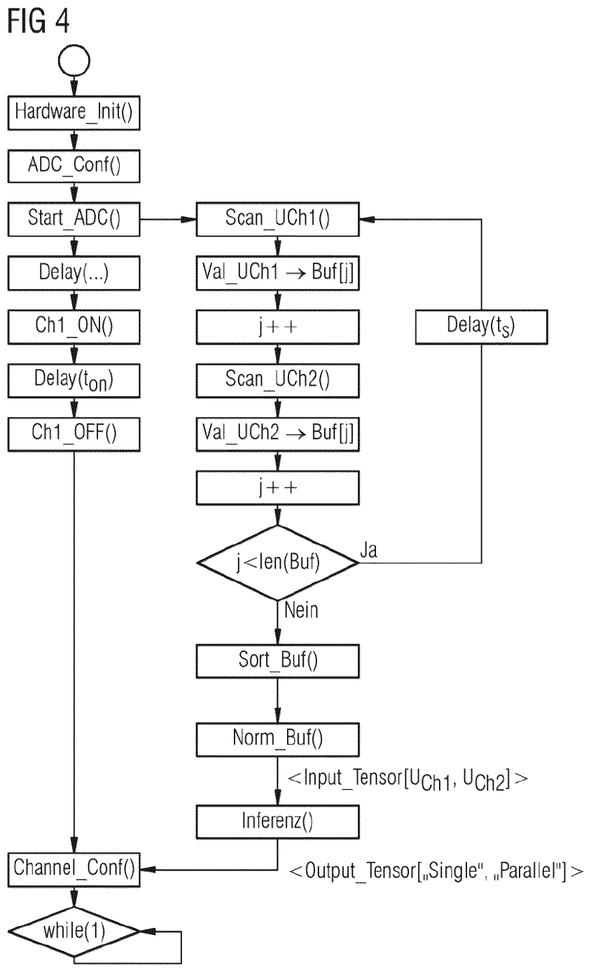

The process flow of the method in accordance with the invention for identifying parallel connections during the device startup in the monitoring facility is shown in FIG. 4.

First, the hardware is initialized Hardware_Init( ). In so doing, the clock frequency is specified, for example, and the configuration of the peripherals of the microcontroller is performed. Subsequently, in step ADC_Conf( ), the analog-digital converter is prepared for the sampling of the output voltages. Here, the length of the buffer, i.e., the number of memory spaces j, is specified, and/or the sampling time ts is determined. The configuration must be calibrated such that enough samples are collected for deployment for operation during the test sequence. The number of samples n, and/or the buffer length j, must be the same as in the training data. Furthermore, the analog-digital converter is set such that the sampling of the data proceeds temporally in parallel with the main process of the controller. This is enabled by Direct Memory Access.

After configuration, the analog-digital converter is triggered Start_ADC( ). The sampling procedure of the analog-digital converter begins and runs in parallel with the test sequence. The test sequence optionally can also start with a slight time delay, in order to be able to take into account hardware-related circumstances. Subsequently, the channel is switched on (Ch1_ON( )) and, after a switch-on time ton of typically a few 100 μs (Delay(ton)), the channel 1 is switched off again (Ch1_OFF( )). During the entire test sequence, both output channels are monitored via the sampling procedure of the analog-digital converter.

Following triggering of the analog-digital converter via Start_ADC( ), the first value of the output voltage of channel 1 is ascertained (Scan_UCh1( )) and written into the first memory space of the buffer (Val_UCh1→Buf[j]), whereupon the memory position is increased (j++). Subsequently, the first value of the output voltage of channel 2 is ascertained (Scan_UCh2( )) and written into the second memory cell of the buffer (Val_UCh2→Buf[j]). Subsequently, the memory address is increased in turn (j++). This procedure is repeated until the buffer is entirely full, where the sampling procedure occurs for the sampling times ts set in advance (Delay(ts)).

Once the buffer is fully written, the data is post-processed. If the order of the values of the output voltage of channel 1 and channel 2 does not correspond to the order in the training data, or peripherals are sampled on two different analog-digital converters, then the data has to be sorted (Sort_Buf( )). Subsequently, the same standardization follows as in the training data (Norm_Buf( )). The values from the analog-digital converter are available as 10-bit integer values. Therefore, standardization by 1024 is expedient. With 12-bit resolution, the standardization factor would be 4096, respectively. After the sorting and standardization, the input tensor is available, so that the inference can be performed. As a result, the output tensor is obtained with the prediction of whether or not a parallel connection of the channels is present.

Based on this information, the monitoring facility can undertake the configuration of the channels (Channel_Conf( )). This makes it possible to adapt the parameters for parallel operation for the further course of the program. This includes, in particular, the current distribution of the channels, adapting the trigger characteristic, restriction times, and/or startup behavior.

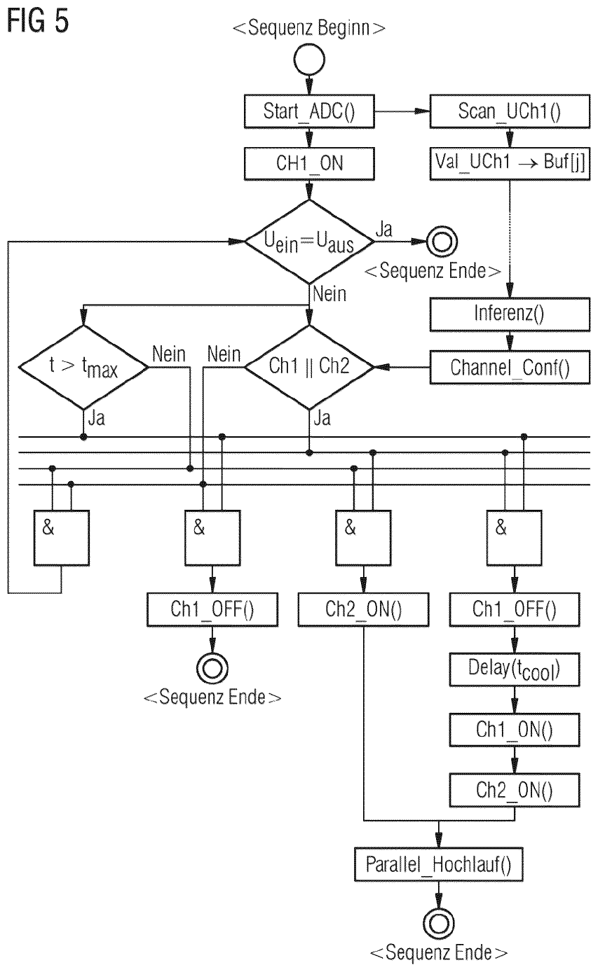

The integration of the method for identifying parallel connections of output channels into the startup of a power supply facility is explained based on FIG. 5.

In this context, no dedicated test sequences are required and a parallel connection is identified during the startup of channel 1. In so doing, the channel 1 is switched on and a maximum switch-on duration tmax is specified. At the same time, all necessary steps are started, in order to be able to perform an inference for identifying parallel connections, which identifies a parallel connection of a further channel, if applicable. This means that the output start of the channel configuration can change during the startup of channel 1. This results in the following scenarios:
a) No parallel connection is present and the channel 1 starts up within the maximum startup time tmax. Here, channel 1 remains switched on and no further steps are necessary. For this, a dedicated abort criterion is necessary, which can exist by the output voltage Uaus reaching the value of the input voltage Uein, taking into consideration a specifiable difference. Furthermore, a sufficient criterion is also to be reached through observation of the output current.
b) No parallel connection is present, channel 1 does not start up within tmax and is switched off again and remains in this state.
c) A parallel connection of channel 1 and 2 is present and is identified within the maximum startup time tmax. Here, the channel 2 is linked and the startup occurs with two parallel channels.
d) A parallel connection of channel 1 and 2 is present, but is only identified once tmax has elapsed (or insufficient remaining time of channel 1 is present, because it is already also too hot for parallel startup). Here, both channels are switched off and parallel startup of channel 1 and 2 occurs after a cool-down time tcool.

The startup of the power supply facility then proceeds as a function of the present scenario, as follows: Once channel 1 has been switched on, there is a querying of the abort condition of whether the output voltage Uaus has (approximately) reached the value of the input voltage Uein (scenario a). Subsequently, both the switch-on duration is monitored, in order to prevent the transistor of channel 1 from becoming too hot, and there is also a querying of whether a parallel connection of a further channel has been identified. This querying is repeated until either the maximum switch-on duration is reached (scenario b) and/or a parallel connection has been identified.

As described earlier, the neural network requires a certain number of samples, in order to be able to identify a parallel connection. Since channel 1 is already starting up, in the case of a parallel connection the output voltage at channel 2 will also change, in a similar manner to the embodiment via test pulses, and thus can be identified.

If the parallel connection is achieved before reaching the maximum switch-on duration (scenario c), then channel 2 is connected and a parallel startup of both channels occurs.

If the parallel connection is only identified after the maximum switch-on duration tmax has elapsed, or insufficient time is remaining for channel 1 for parallel startup (scenario d), then channel 1 is switched off and, after a cool-down time tcool, a parallel startup of the channels occurs.

The exemplary embodiments describe the use of the neural network only for two output channels. The embodiments of the invention can, however, be applied to application cases with almost any given number of channels, without limitations.

Furthermore, it is possible to detect not only one measurement value, but rather any given number of measurement values for the channels, and to then write these into the input tensor.

Additionally, it is also conceivable to perform multiple inferences at the same time, so that multiple combinations are evaluated at the same time. A serial process flow of inferences is also conceivable, in order to either use the same neural network for an identification of adjacent channels (1∥2 2∥3 3∥4) in each case, thus saving memory space in the target hardware, or multiple different inferences, in order to detect further combinations. Finally, neural networks can also be trained for the identification of multiple states. By expanding the output tensor, it is also possible to map all combinations of the output channels (1∥2∥3 2∥4 1∥3∥4, etc.).

The method in accordance with the disclosed embodiments of the invention can also be used in ongoing operation of a power supply facility. Additionally, instead of the voltage waveforms, it is also possible to use the output current waveforms as data for the neural network. If the current setpoint value is now briefly modified at one channel, then either the output voltage and/or the output current is used as identification signal of a parallel connection.

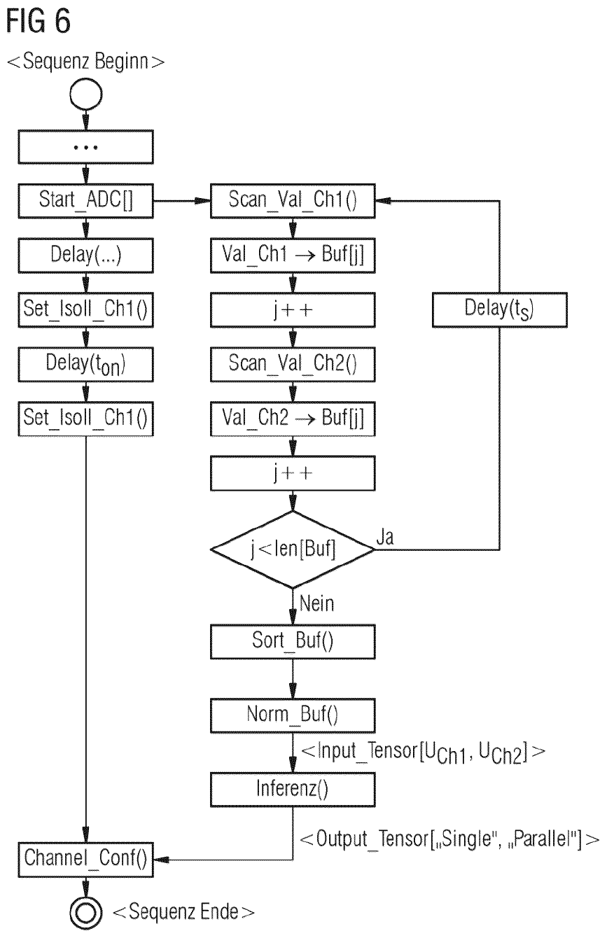

FIG. 6 shows the process flow during operation as a sequence within a program process flow in the source code of the μC. In this context, this can continuously be part of the main program, as well as a cyclically called auxiliary program. The procedure is started by the triggering of the analog-digital converter, where the scan procedure of the analog-digital converter is executed in parallel with the test sequence. Through the modification of the setpoint value Set_IsollCh1( ) under the current value of the load current, the current is regulated back in the channel. Consequently, either the voltage at the output becomes lower or the current is taken over by a channel connected in parallel. A neural network can thus be trained so that identification can occur both via the voltage change at the output, provided that this occurs at both channels, and via the current change in the channels. After a certain test duration (Delay(ton)) from some 100 μs to a few ms (or even longer, if applicable, provided that there is no risk to stable operation), the setpoint value of channel 1 is adapted again and thus regular operation is established again. At the same time, the output voltage and/or the output current of both channels is monitored via the analog-digital converter. After triggering the analog-digital converter, in turn the first measurement value of the channel 1 is detected (Scan_Val_Ch1)) and written into a buffer (Val_Ch1→Buf[j]). Once the memory position (j++) is increased, the measurement value at channel 2 is detected (Scan_Val_Ch2( )) and written into the buffer (Val_Ch2→Buf[j]). In turn, once the memory address of the buffer (j++) has been increased, the entire procedure is repeated with the sample rate ts (Delay(ts)) until the buffer is full. Subsequently, if applicable, the measurement values are sorted (Sort_Buf( )) and standardized (Norm_Buf), whereupon the inference (Inferenz( )) is performed. If a parallel connection of the channels is identified in this case, then these are configured accordingly and the associated parameters are adapted (Channel_Conf( )).

When the parallel connection identification is linked into the processing of the main program of the monitoring facility, there is no testing for the presence of a parallel connection via a test process flow, but rather during runtime of the program via the measurement values that are ascertained in any case.

In the main loop of the program of the monitoring facility, in any case the measurement values of the output variables are ascertained, in order to be able to respond accordingly in the event of an error, such as on occurrence of overcurrents or a short-circuit, etc. Here, the measurement values are not discarded again after each run, but rather are written into the buffer. If enough values are collected in order to form an input tensor for the neural network, then an inference is performed and, if a parallel connection is identified, the channels are configured and parameterized accordingly. It should be noted that, for the presently contemplated embodiment, in turn it is necessary to run through the entire method, consisting of the steps 1 . . . 5 with the adaptations necessary therefor.

It is also conceivable to identify the parallel connection of multiple devices, i.e., a combination of electronic fuses. If the supplying network device or devices vary their output voltage, then this occurs to the same extent at the inputs of electronic fuses connected in parallel. The input voltage of the electronic fuse is monitored in any case. For device families that are equipped accordingly, it is possible for information to be exchanged via a communication bus. One of the devices can be defined as master in the combination, on which the inference is performed.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A method for identifying parallel connections of output channels in power supply facilities, a neural network implemented in a first digital computer of a monitoring facility being provided to identify the parallel connections, the method comprising:
triggering different operating states and measuring at least one of associated voltage waveforms (UoutCh1, UoutCh2) and current waveforms at output channels to ascertain training data for the neural network in a power supply facility,
transmitting the ascertained training data (UCh1[0] UCh2[1] UCh1[2] UCh2[3] . . . UCh1[j−3] UCh2[j−2] UCh1[j−1] UCh2[j]) to a further digital computer, via which the training of the neural network occurs; and
implementing a trained, ready-to-use neural network in the first digital computer of the monitoring facility and utilizing the trained, ready-to-use neural network to identify the parallel connections.

11. The method as claimed in claim 10, wherein the power supply facility comprises an analog-digital converter, which is connected on an input side to output channels of the power supply facility and on an output side to the monitoring facility.

12. The method as claimed in claim 11, wherein, in order to ascertain training data for the neural network in the power supply facility, different operating states with different load conditions with and without parallel connection; and wherein output voltages at the channels (UoutCh1, UoutCh2) are measured, digitized via the analog-digital converter and stored as the training data (UCh1[0] UCh2[1] UCh1[2] UCh2[3] . . . UCh1[j−3] UCh2[j−2] UCh1[j−1] UCh2[j]) in a memory of the digital computer of the monitoring facility.

13. The method as claimed in claim 12, wherein the transfer of the digitized data from the analog-digital converter into the memory of the digital computer of the monitoring facility occurs via Direct Memory Access.

14. The method as claimed in one of claim 10, wherein a multilayer feed-forward network is utilized as the neural network which, in addition to an input layer and an output layer, also comprises hidden layers.

15. The method as claimed in claim 10, wherein available training data is divided into core training data, validation data and test data; and wherein approximately 60% of the training data is utilized for the training, 20% of the training data is utilized for validation of a model, and a further 20% is utilized for testing of the neural network.

16. The method as claimed in claim 10, wherein ascertaining training data for the neural network occurs via a further piece of hardware which is independent from the monitoring facility.

17. The method as claimed in claim 10, wherein an output channel is briefly switched on and switched off again to identify a parallel connection.

18. The method as claimed in claim 10, wherein, in different operating states, in each case at least one of different loads are connected to the power supply apparatus and different input voltages are applied.
